(19) United States
(12) Patent Application Publication
(10) Pub. No.: US 2004/0079540 A1
(43) Pub. Date: Apr. 29, 2004

(54) Manure scraper

(76) Inventors: Stanley E. Zambahlen, Newton, IL (US); Richard J. Johnson, Arlington, VA (US)

Correspondence Address: Richard J. Johnson, 5612 18th St N, Arlington, VA, 22205-2813, US

(21) Appl. No.: 10/649,639

(22) Filed: Aug. 28, 2003

Related U.S. Application Data
(63) Continuation-in-part of application No. 08/504,488, filed on Jul. 19, 1995, now abandoned.
Application No. 08/504,488 is a continuation of application No. 08/110,007, filed on Aug. 23, 1993, now abandoned.

(51) Int. Cl. A01B 31/00

(52) U.S. Cl. 172/684.5

(57) ABSTRACT

A scraper designed for use in scraping manure from livestock feedlot areas. The scraper has a semi-circular configuration in plan. A horizontal beam connects the forward ends of the semi-circular blade and supports a tower providing an upper three-point hitch connection and spaced lower three-point connections. Reinforcing struts extend downwardly from the tower and are welded to an upper portion of the blade. The blade and scraping edge are constructed from non-hardened hot rolled soft tempered steel, which is permitted to wear away in a self-sharpening manner during use over abrasive concrete surfaces. Wear strips of non-hardened mild steel or polyurethane may be bolted to the scraper to serve as the scraping blade. The scraper has a substantially open top permitting visual observation by the operator and can be operated at relatively high speeds over rough and irregular concrete surfaces and scrape frozen or dried material therefrom without the danger of the blade edge catching on a surface projection and causing damage.

This application is a continuation-in-part of my previous application Ser. No. 08/504,488 filed Jul. 19, 1995, which is a continuation of application Ser. No. 08/110,007, filed Aug. 23, 1993, now abandoned.

### FIELD OF THE INVENTION

A three-point hitch mounted scraper having an arcuate blade designed for scraping concrete animal feedlot surfaces for the removal of manure and other debris.

### BACKGROUND OF THE INVENTION

Concrete surfaced areas such as livestock feedlots require periodic cleaning. This presents a challenge for conventional scrapers because the concrete surfaces are abrasive and often have raised edge abutments, caused by soil “heaving” resulting from normal temperature changes, or other surface projections or grooves that could catch on conventional straight edged sharpened blades. Conventional straight blades generally have a concave configuration in cross-section and have a hardened blade with a sharpened cutting edge disposed at an acute angle to the surface being scraped. Such blades are specifically designed to have a digging and excavating action to remove or cut away surface irregularities and not merely to ride over those which cannot be easily removed. Since the conventional steel blade is straight, has a sharpened edge, and is in a cutting angle disposition toward the concrete surface there is a constant danger of it being caught on a projection or in a groove resulting in damage to the entire scraper or at least requiring the replacement of an expensive hardened steel cutting blade.

Because of the above noted dangers the speed at which a conventional straight cutting blade can be operated on irregular concrete surfaces must be limited to reduce the risk of serious damage to the blade as a result of the blade “catching” on a surface obstruction. Straight blades also have restricted utility in moving loose scraped material because in addition to having limited capacity the material that is collected thereon tends to slide off during turning and maneuvering of the towing vehicle in the often cramped feedlot spaces encountered.

Attempts have been made as shown in the prior art to construct scrapers for use on such concrete surfaces using segments of discarded tractor tires. While such do not become caught on surface abutments the inventor has found that they leave a very slippery surface creating a hazard that can cause injuries to livestock. In other instances a resilient rubber material blade or resilient scraping edge merely flexes and slides over any debris which is strongly adhered to a concrete surface, such as, being frozen thereto in winter or being dried and packed thereon in summer.

The inventor is also aware of certain prior art arcuately configured scrapers that are totally enclosed from above. This design has been found at times to restrict the capacity of the scraper in that the scraped material, and especially manure that contains some straw and hay residue, tends to bunch-up at the front end or mouth of the scraper blocking further material from entering. Also, the enclosed top substantially restricts the vision of the operator and thus he is unable to fully monitor the scraper performance and make adjustments in the operation of the implement.

Other prior art of which the applicant is aware and which has been cited in the previous applications listed above are: 78,583; 303,737; 1,088,414; 1,653,559; 2,063,698; 2,315,591; 2,749,825; 2,983,060; 2,888,996; 3,034,238; 3,089,264; 3,829,991; 3,795,069; 3,915,238; 4,048,929; 4,094,453; 4,061,194; 4,103,796; 4,196,778; 4,212,254; 4,266,625; 4,337,833; 4,363,152; 4,619,010; 4,669,206; 4,723,609; 4,805,322; 4,818,349; 5,075,985; 5,172,499; 5,191,944; 5,289,879; GB 849,677; FR 753,073

Best of Farm Show'89 1989 pg. 16

Bush Hog Rear Mounted Blades and Scrapers

It is a primary object of the invention to provide an improved manure scraper for concrete surfaces that will overcome the various shortcomings of the prior art as noted above and to provide a large capacity scraper that is inexpensive to produce and which is effective in removing strongly adhered material from concrete surfaces.

It is a further object to provide an improved three-point hitch mounted manure scraper that can be operated efficiently at relatively high speeds without danger of damage.

It is a further object to provide a substantially semi-circularly shaped non-hardened “sacrificial” blade having a flat or blunt surface contacting edge portion for sliding scraping movement over a concrete surface.

### BRIEF DESCRIPTION OF THE DRAWINGS

FIG. 1 is a front view of the scraper.

FIG. 2 is a top view of the scraper.

FIG. 3 is a perspective view of the scraper having a slightly modified scraping edge.

FIG. 4 is a fragmentary front view of the scraping edge showing a wear resistant scraping edge member.

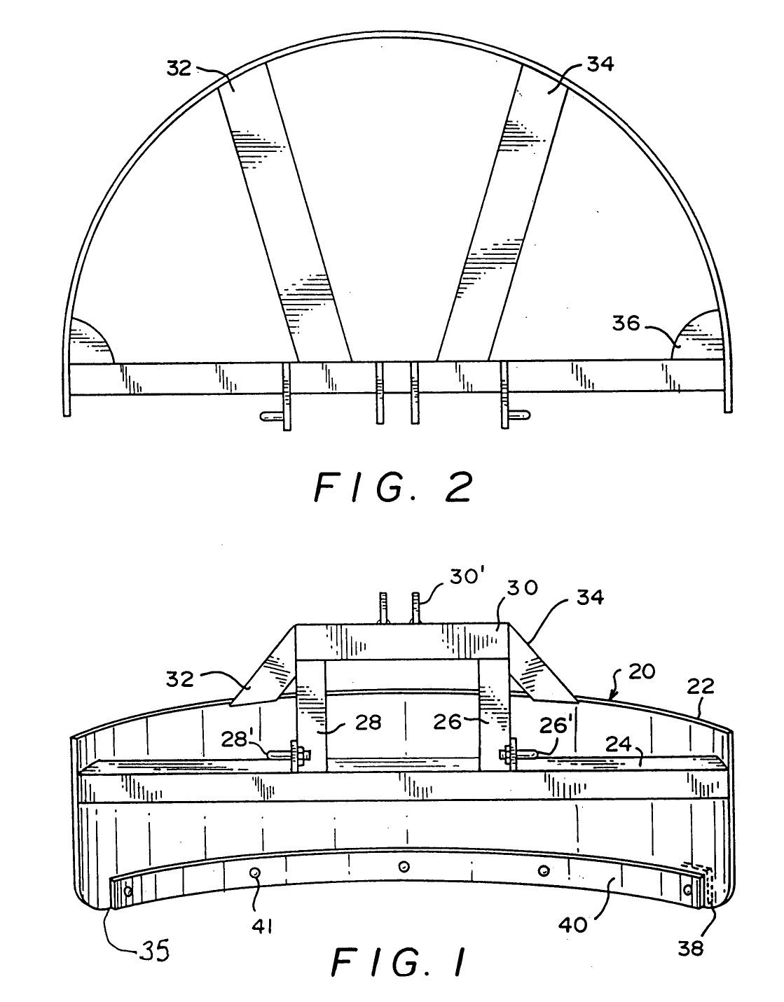

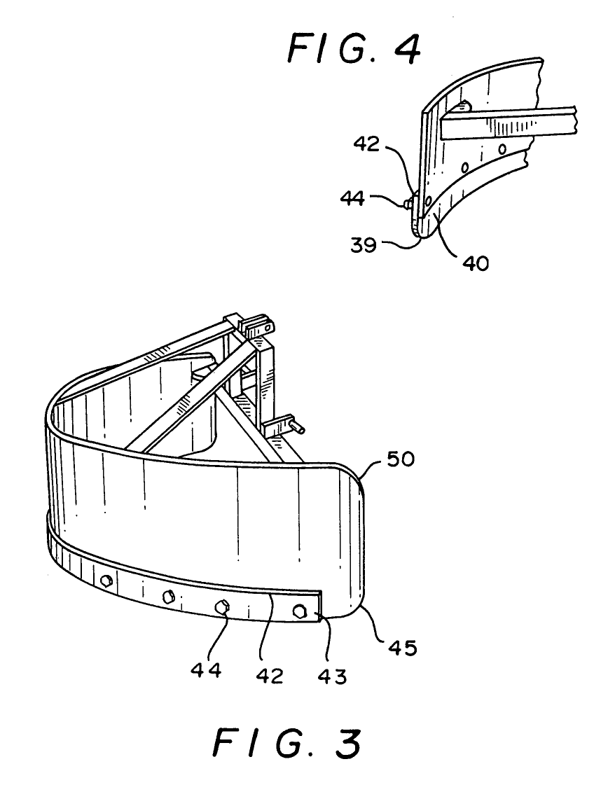

### DETAILED DESCRIPTION OF THE INVENTION

Referring now to the drawings the scraper 20 includes a generally semi-circular blade 22 of uniform thickness of hot rolled soft tempered steel approximately one-half inch thickness. The height of the blade may be 18 inches or more to provide a large holding capacity for the build-up of scraped material and to allow for the gradual wearing away of the blade material as a result of its usage over abrasive concrete surfaces. A hollow tubular crossbeam 24 has opposite ends welded to the end portions of blade 22. Gusset members 36 are welded between the ends of beam 24 and blade 22. The three-point hitch tower is formed by spaced upright members 26, 28 and transverse connecting bar member 30. Upper three point connection 30′ is attached to the transverse connecting bar member 30. Lower three-point connections 26′ and 28′ are welded to the lower ends of the tower upright members 26, 28, to the crossbeam 24, or to both, depending on the three-point hitch category intended and the required spacing.

Downwardly and rearwardly angled strut members 32 and 34 extend in diverging relationship from laterally spaced portions of the upper transverse connecting bar 30. The lower ends of the strut members are welded at angularly spaced locations along the upper edge portion of the blade 22. The design and position of the struts reinforces the hitch tower and permits substantial down pressure on the blade when needed. The downward and rearward angle of the struts and their limited size leaves the top and front of the blade substantially open and unobstructed and increases the holding capacity of the scraper over those which have a closed top while also substantially restricting any rearward spillover of the contents. At the same time, the generally unobstructed open top construction permits continual visual monitoring by an operator of the build-up of scraped material during loading.

The lower front corners of the blade 24 are rounded as shown at 35. While it is preferred to leave the lower scraping edge of the non-hardened blade 22 without any additional wear strip or hardened wear rubbing strip and to permit it to gradually wear away during use it is also possible to provide some type of wear strip. In one embodiment, the lower inner portion of the arcuate blade 22 is reinforced by a metal wear strip 40 secured to the inner face of the blade by bolts 44. Alternatively, the wear strip 40 could be formed from polyurethane, which has known usage in scraping blades because its high resistance to wear, as disclosed in the patent to Wagner U.S. Pat. No. 3,477,149, filed Dec. 7, 1967. The entire disclosure of this patent is incorporated herein by reference. A polyurethane blade could also be secured by bolts 44 to the inner surface of the blade. Thus, the blade 22 can include a metal or a polyurethane wear strip or no wear strip at all and the unhardened blade material can be simply allowed to gradually wear away with very little affect on the operation of the scraper. In any event the vertical surface of the blade is perpendicular to the surface being scraped and the rubbing contact scraping edge portion is flat or blunt such that it merely slides over the surface without attempting to “scoop out” or cut below the surface thereof. Because of the semi-circular blade configuration most obstructions will be engaged at an angle to the direction of travel and thereby allowing the blade to rise over them rather than being caught.

The configuration of the blade together with the three-point hitch mounting enables the scraper to be operated at relatively high speeds over rough concrete surfaces without danger of catching the edge of the blade on surface projections. The arcuate or semi-circular blade configuration and the perpendicular orientation aids in preventing the blade from being caught and allows the blade to simply ride up and over surface projections. The gradual wearing away of the hot rolled non-hardened soft tempered blade material in a “sacrificial” nature is usually a very gradual process and it has been found that in normal usage a blade will last for years and should last the expected life of the scraper. Additionally, the abrasive rubbing and wearing away of the blade edge against the concrete surface creates a self-sharpening action on the blade edge enabling it to dislodge material adhered to the concrete.

It is apparent that numerous modifications could be made to the specific details disclosed herein without departing from the overall spirit of the invention. For example, the length and height could be varied. The curvature of the blade while preferably semi-circular could have a longer radius of curvature and still accomplish most of the stated objectives.

It is apparent that numerous modifications could be made to the specific details disclosed herein without departing from the overall spirit of the invention. For example, the length and height could be varied. The curvature of the blade while preferably semi-circular could have a longer radius of curvature and still accomplish most of the stated objectives.

Having described my invention I claim:

1. A scraper adapted for use in scraping frozen and hardened manure and other debris from concrete surfaces comprising:
a generally semicircular shaped metal scraping blade as view in plan having forwardly disposed end sections,
a crossbeam extending between and rigidly connected to said forwardly disposed end sections, a central portion of said crossbeam having spaced lower three-point hitch connections secured thereto and a support tower including an upper three-point hitch connection,
said blade being of uniform thickness non-hardened metal and having a lower scraping portion provided with a continuous flat metal surface for sliding contact with a flat concrete surface and for scraping material therefrom,
said lower scraping portion being configured so as to be perpendicular throughout its length to a flat concrete when in use,
rigid strut means extending downwardly and rearwardly from said support tower and secured to an upper portion of said blade whereby to rigidly support said blade against upward movement and to limit overflow of debris from said scraper,
the top of said scraper being otherwise open and unobstructed to the view of an operator on a towing vehicle.

2. The scraper of claim 1, wherein the blade lower portion includes a continuous arcuate wear strip member having a flat lower scraper sliding surface.

3. The scraper of claim 2 wherein the wear strip is metal.

4. The scraper of claim 2 wherein the wear strip is polyurethane.

5. The scraper of claim 2 wherein the wear strip members are bolted to the blade.

6. The scraper of claim 4 wherein the wear strip member is bolted to the blade.

7. The scraper of claim 1 wherein the strut members comprise a plurality of downwardly and rearwardly diverging members secured to an upper portion of the blade.

8. The scraper of claim 1 wherein said tower comprises a pair of laterally spaced upright members connected at their upper ends by a transverse connecting bar.

9. A scraper for use in scraping hardened manure and other debris from concrete surfaces comprising:
an elongated non-hardened hot rolled soft tempered mild steel scraping blade of generally semicircular open top configuration as viewed in plan having forwardly disposed end sections and a lower scraping portion,
a crossbeam extending between and rigidly connected to said forwardly disposed end sections,
three-point hitch connections comprising a pair of spaced lower hitch connections and a support tower having an upper; hitch connection secured to a central portion of the crossbeam,
strut members extending downwardly and rearwardly from said tower and secured to an upper portion of said blade, the top of said scraper being otherwise open and unobstructed to the view of an operator of a towing vehicle,
and wherein at least the blade lower portion is configured to be perpendicular to a horizontal surface being scraped and includes a continuous lower flat or blunt surface for sliding self-sharpening contact with said surface being scraped.

10. The scraper of claim 9 wherein said tower comprises a pair of laterally spaced upright members connected at their upper ends by a transverse connecting bar.

10. The scraper of claim 9 wherein the strut members extend downwardly and rearwardly from said transverse connecting bar.
